(19) United States
(12) Patent Application Publication
(10) Pub. No.: US 2025/0011129 A1
(43) Pub. Date: Jan. 9, 2025

(54) DEVICE FOR DETECTING FAULTS IN AN ELEVATOR SYSTEM, METHOD OF DETECTING FAULTS IN AN ELEVATOR SYSTEM, AND USE OF A DEVICE

(71) Applicant: Inventio AG, Hergiswil (CH)

(72) Inventor: Pietro Bonomi, Verbania (IT)

(21) Appl. No.: 18/707,249

(22) PCT Filed: Nov. 4, 2022
(86) PCT No.: PCT/EP2022/080771

§ 371 Date: May 3, 2024

(30) Foreign Application Priority Data
Nov. 10, 2021 (EP) 21207568.3

(51) Int. Cl. B66B 5/00; B66B 1/34; B66B 3/00; G06T 11/00; G06T 11/20

(52) U.S. Cl. CPC B66B 5/0037; B66B 1/3461; B66B 3/002; B66B 5/0018; B66B 5/0087; G06T 11/001; G06T 11/206

(57) ABSTRACT

A device for detecting faults in an elevator system includes an interface module for connecting the device to an interface of the elevator system, a visual output module, and a processing module. The processing module receives, by the interface module, status information from the elevator system. The status information includes health indicators indicative of a health of components of the elevator system, and communication indicators indicative of a communication quality between communicatively connected components of the elevator system. The processing module calculates, from the status information, a tree-type health status graph of the elevator system. The processing module displays, by the visual output module, a visual representation of the graph of the elevator system. The visual representation includes icons representing the nodes, icon modifiers representing the health indicator attribute of the nodes, and lines representing the links.

### FIELD

The present invention relates to elevator systems for passenger transport and the detection of faults in elevator systems, and particularly relates to monitoring, servicing and/or maintenance of the elevator system. A device for generating a visual representation of a graph representing the elevator system is described.

### BACKGROUND

Modern elevator systems often include several communicatively connected components, such as controllers, sensors, operating panels, motors, actuators or the like. Each component may be provided to perform a function related to the elevator system, and may be connected to various sub-components, for example, an elevator door controller may be connected to a motor for opening and closing the door, a sensor for determining if the door is open or closed, a lock for locking and unlocking the door, a light barrier for determining if obstructions are present within the door space, and further such sub-components.

If a component or sub-component fails due to a fault, an error or alarm may be raised, and the elevator system may become inoperable, particularly if the faulty component is safety relevant. A fault may include a loss of communication with the component or a failure of the component itself. A fault may also result from the normal operation of a safety sensor, if the safety sensor detects or indicates an unsafe state. To bring back the elevator system into its operating state, the fault must be identified and corrected. Even more preferably, a faulty component or connection that is about to fail should be detectable before the elevator system becomes inoperable.

With the increasing complexity of elevator systems, detecting such faults becomes more difficult. Furthermore, it is often not easily possible to detect components that are about to fail, or only fail in certain situations, since the overall status information of the full elevator system is often not readily accessible for monitoring the health of the elevator system components in a simple and efficient manner.

### SUMMARY

Thus, there is a need for a solution that improves the detection of faults in an elevator system. The device and method described herein may solve this problem at least in part.

According to an aspect, a device for detecting faults in an elevator system is described. The device includes an interface module for connecting the device to an interface of the elevator system, a visual output module, and a processing module. The processing module is configured for receiving, by the interface module, status information from the elevator system. The status information includes health indicators indicative of a health of components of the elevator system, and communication indicators indicative of a communication quality between communicatively connected components of the elevator system. The processing module is further configured for calculating, from the status information, a tree-type health status graph of the elevator system. The graph includes nodes representing the components of the elevator system, each node including a health indicator attribute based on the health indicator of the components associated with the node, and links between nodes, the links representing a connection between communicatively connected components of the elevator system, each link including a communication indicator attribute based on the communication indicator of the communicatively connected components associated with the link. The processing module is further configured for displaying, by the visual output module, a visual representation of the graph of the elevator system. The visual representation of the graph includes icons representing the nodes, icon modifiers representing the health indicator attribute of the nodes, and lines representing the links.

According to an aspect, a method of detecting faults in an elevator system is described. The method includes communicatively connecting a device to an interface of the elevator system, and receiving status information from the elevator system, the status information including health indicators indicative of the health of components of the elevator system, and communication indicators indicative of the communication quality between communicatively connected components of the elevator system. The method further includes calculating, from the status information, a tree-type health status graph of the elevator system. The graph includes nodes representing the components of the elevator system, each node including a health indicator attribute based on the health indicator of the components associated with the node. The graph further includes links between nodes, the links representing the connection between communicatively connected components of the elevator system, each link including a communication indicator attribute based on the communication indicator of the communicatively connected components associated with the link. The method further includes displaying a visual representation of the graph of the elevator system. The visual representation of the graph includes icons representing the nodes, icon modifiers representing the health indicator attribute of the nodes, lines representing the links, and optionally line modifiers representing the communication indicator attribute of the links.

According to an aspect, an elevator system is described. The elevator system may be an elevator system configured for transporting passengers, e.g. in a building. The elevator system may include one or more components, such as a plurality of components. A component of the elevator system may be a device communicatively connected with further components of the elevator system, e.g. a device connected in a communication network, such as a local communication network, of the elevator system. A component of an elevator system may be a device functionally related to the operation, safety, communication and/or monitoring of the elevator system. A component of the elevator system may be a device permanently or transiently associated with the elevator system. A component of the elevator system may further include devices indirectly associated with the elevator system, such as devices associated with the environment of the elevator system, such as a communication gateway connecting the elevator system to a wide area network, a traffic monitoring system, a configuration device used during setup or maintenance of the elevator system, an alarm device configured e.g. for receiving alarms, such as fire alarms, from an alarm network, a shaft light or a controller controlling a shaft light.

According to an aspect, a communicative connection does not require a dedicated communication line. For example, a power block, such as a power converter, may be considered communicatively connected to the main power supply, and the communication between the main power supply and the power block may include the information of whether the main power supply is delivering power or not delivering power. Likewise, an electrical connection to a battery may include information about the charging state of the battery. An electrical and/or mechanical device, such as a lock, a light or a motor, may be driven by a controller, and the communicative connection may result from the controller sensing if the device operates within expected parameters.

According to an aspect, a component of the elevator system may be a device included in the elevator system, such as, for example, a landing operating panel. Several components of the elevator system may be included in a single device, for example, a landing door controller may include a component for monitoring the landing door status, a controller for controlling the door motor for opening and closing the landing door, and a communication interface for communicatively connecting the landing door controller to the elevator communication network. Several components of the elevator system may form a component of the elevator system, for example, a car safety controller may combine the readings of several devices, such as sensors, and the car safety controller in combination with the sensor may be the car safety component. A component of the elevator system may be representative of a group of components or sub-components. For example, a plurality of landing doors, such as all landing doors of the elevator system, may be the component “landing doors”. A component of the elevator system, particularly a component representing a group of components of the elevator system, may be a virtual component, i.e. some components may not be separate, physical entities, but be defined e.g. according to the structural or functional relationship of the sub-components forming the virtual component.

According to an aspect, a device is described. The device may be a device for detecting faults in an elevator system, and a method of monitoring faults in an elevator system may include the device and/or the use of the device. The device may be used for monitoring faults in an elevator system. The device may be a stationary device, such as including a (fixedly installed) monitoring panel. The device may include a computer, such as a software implemented on a computer or a plurality of computers, such as a plurality of cloud computers. The device may be, fully or in part, provided in the building including the elevator system, or even in a remote location, such as a service center.

According to an aspect, the device may be a tool for use by a service technician. The device may be a portable or handheld tool, such as a diagnostic tool, such as a tool for use by a user during service or maintenance, such as a PDA, a tablet, a smartphone, a laptop computer or the like.

According to an aspect, the device is configured for detecting faults in an elevator system, i.e. the device may be configured for automatically detecting faults in an elevator system, and/or assisting a user of the device in detecting faults in an elevator system.

According to an aspect, the device includes an interface module for connecting the device to an interface of the elevator system. The interface module may be a networking module for connecting the device to a network of the elevator system. The network of the elevator system may communicatively connect components of the elevator system, such as described herein with reference to aspects and/or embodiments. The interface module may be a data interface. The interface module may include a network adapter, such as a wireless network adapter, such as a W-LAN adapter, or a wired network adapter, such as an Ethernet adapter. The interface module may be any kind of interface commonly used for communicating with known components of an elevator system, particularly at the date of filing of this specification, including, but not limited to, USB adapters, serial adapters, MODBUS, I²C, or the like. According to embodiments, the elevator system may be communicatively connected to a wide area network, such as the internet, and the device may be, by the interface module, connectable to the same wide area network, particularly for receiving status information from the elevator system.

According to an aspect, the device includes a visual output module. The visual output module may be a display. The visual output module may include a display device, such as a flat-panel display, such as an LCD or OLED display or the like. The visual output module may be a dedicated display panel, e.g. a display panel specifically adapted to display icons and lines corresponding to a specific elevator system, e.g. by an arrangement of indicator lights, lamps, pixels or the like, and is not limited to any type of display technology.

According to an aspect, the device includes a processing module. The processing module may be a processor. The processing module may include a central processing unit (CPU) and a memory. The memory may include a set of instructions, e.g. a software program, to be executed by the CPU, according to aspects and/or embodiments described herein. The processing module may be connected to the visual output module and the interface module. The processing module may be configured for transmitting and receiving signals, particularly data, to and from the visual output module and the interface module, particularly according to aspects and/or embodiments described herein.

According to an aspect, status information is received, by the device, from the elevator system. Receiving the status information may include connecting the interface module to an interface of the elevator system. According to embodiments, an elevator system, such as a controller of the elevator system, may aggregate the status information such that a single connection is sufficient for receiving status information from all or most of the components of the elevator system. According to embodiments, several connections may be established, particularly in cases where the status information is not or not fully aggregated by the elevator system, and/or in cases where a connection between components of the elevator system has failed.

According to an aspect, the status information includes health indicators and communication indicators. A health indicator is indicative of the health of a component. Typically, for functional components, a health indicator may include data indicating an overall health status of the component, such as a health score, a series of log entries indicative of the state of the component, a maintenance indicator indicating the present or future requirement for maintenance, a sensor reading, or any other type of health indicator commonly used in the art. The health indicator may be provided by the component itself, e.g. a door controller may provide a health indicator indicating that the door controller is fully functional. The health indicator may further be provided by a related component, e.g. a door controller may provide a health indicator of a door motor controlled by the controller, or a sensor connected to the controller. A health indicator may also be derived from an absence of a health indicator in the status information, which may be the case for failed, i.e. inoperable components, which may not be communicating at the time the status information is received.

According to an aspect, a communication indicator is indicative of a communication quality between communicatively connected components of the elevator system. The type of communicative connection between components may be different according to the communicatively connected components. For example, an elevator car controller may be communicatively connected to a main elevator controller with a dedicated wired connection, the landing operating panels may be each connected in a wireless or wire-based data network connected to the main elevator controller, a safety module may be connected in a safety-redundant separate data network with multiple safety-relevant controllers taking sensor readings. The sensor readings may be provided by the sensors according to their configuration, i.e. they may provide analog or digital signals e.g. to the safety-relevant controllers.

According to an aspect, the status information may include, for at least one component or all components of the elevator system, an identifier of the component.

According to an aspect, a communication quality indicated by a communication indicator may be a quality of communication. The communication quality may be determined by one or all, e.g. both, of a set of communicatively connected components of the elevator system. The communication quality may further be determined by a separate component, such as an elevator controller, e.g. upon checking the communication quality between the separate component and the set of communicatively connected components of the elevator system. The communication quality may be provided as any suitably type of information, such as a score, a signal-to-noise ratio, an indicator or the like. In the context of this disclosure, “good communication quality” and “low communication quality” are used as expressions to discern typical, exemplary cases. A normal communication according to the specifications of the communicative connection is generally considered a good communication quality. For example, two components of the elevator system connected in a data network, such as, for example, an ethernet network, so that an uninterrupted transmission of data packets is possible between the two components with low latency, are considered to have a good communication quality. A low communication quality, as indicated by the communication indicator, may be a communication that is, at least intermittently, interrupted, has a high latency, has a low signal-to-noise ratio, has a high transmission error rate and/or experiences any other type of complication in transmitting signals or data between communicatively connected components of the elevator system.

According to an aspect, a failed component that is inoperable may be considered as having no communication quality, particularly a communication quality indicating a failed connection, between any component connected thereto. Accordingly, if no communication indicator is provided or providable for a failed communication, the lack of the communication indicator indicates no communication, i.e. no communication quality.

According to an aspect, if a first component is communicatively connected through a failed component with a second component, the communication between the first component and the second component may be considered as having no communication quality, particularly a communication quality indicating a failed connection, even though the first component and the second component may have a good communication quality with other components.

According to an aspect, a tree-type health status graph of the elevator system is calculated from the status information. A graph may be a virtual construct. A graph may be a graph according to graph theory. A graph may be definable as a structure amounting to a set of objects in which at least some pairs of the objects are related. A graph may include nodes and links. A tree-type graph may be an undirected graph in which any two vertices are connected by exactly one path, or equivalently a connected acyclic undirected graph. Calculating the graph may include processing the status information. Calculating the graph may include (procedurally) generating a graph based on information included in the status information. Calculating the graph may include classifying the status information, e.g. according to information included in the status information, such as a component identifier, and extracting and/or linking information included in the status information, particularly health indicators and communication indicators, to nodes and links, particularly in the form of health indicator attributes and communication indicator attributes, to the nodes and links. Classification may include classifying the health indicators and communication indicators according to a score. Classification may include deriving, from the respective score, a health indicator attribute including the score and/or a communication indicator attribute including the score. The health indicator score may, for example, include the classes “OK”, “Warning”, “Fail”. The communication indicator score may, for example, include the classes “Strong signal”, “Weak signal”, “No Signal”. The graph may be stored in a memory of the device.

According to an aspect, the graph includes nodes. A node may be a vertex. The graph includes links. The links may be paths. The nodes and/or the links may include attributes and/or have attributes associated with the node. The nodes represent the components of the elevator system. The node includes a health indicator attribute based on the health indicator of the component or components associated with the node. The component associated with the node may be directly associated with the node, i.e. the component represented by the node. The components associated with the node may also include information derived from components indirectly associated with the node, and/or attributes of the node may be inherited from a sub-node. For example, the health indicator attribute of a node representing a sub-component may be inherited by the higher-level node associated with the sub-node, e.g. a failed landing door may have a health indicator attribute indicating the failure, and a higher-level node, such as a node representing all landing doors may inherit the health indicator attribute indicating the failure. Likewise, the communication indicator attribute of a link representing a connection between sub-component may be inherited by the higher-level link associated with the sub-node, i.e. be inherited from the sub-node by the node, and/or from the node by the sub-node. For example, a failed landing door may have a communication indicator attribute indicating no connection, and a higher-level link, such as a link representing a connection between all landing doors and the root node may inherit the communication indicator attribute indicating no connection.

According to an aspect, a node may include an identifier attribute identifying the component or components associated with the node. Each node may include an identifier attribute based on the identifier of the component of the elevator system. For nodes not corresponding to components of the elevator system, such as virtual nodes or nodes grouping a group of components, the identifier attribute may be derived from the group of components, for example, a node grouping a group of safety relevant components may be identified as “Safety”, and a node grouping the landing doors may be identified as “Landing doors”. The links are links between nodes, i.e. two nodes may be connected by a link. The links represent a connection between communicatively connected components of the elevator system, i.e. the links may represent the communicative connection, particularly according to the underlying connection topology between the components of the elevator system. The links each include a communication indicator attribute based on the communication indicator of the communicatively connected components associated with the link. The communication indicator attribute may correspond to the communication quality between the components associated with the link, or may be derived from the communication quality. For example, the communication indicator attribute may include a set of classes, representing a “strong signal” corresponding to a good communication quality, a “weak signal” corresponding to a low communication quality, and “no signal” corresponding to no communication or no communication quality. In cases where the communication quality is represented as a score, the communication indicator attribute may be classified according to the score.

According to an aspect, the processing module is configured for displaying, by the visual output module, a visual representation of the graph of the elevator system. The visual representation may include utilizing the visual output module according to aspects and/or embodiments described herein.

According to an aspect, the visual representation of the graph includes icons representing the nodes. An icon may include an essentially geometrical shape, such as a two-dimensional shape, such as a circle, a box, an ellipse, a hexagon, an octagon, or the like. The icon may include additional information, such as text.

According to an aspect, the visual representation of the graph may include, for each node, an identifier, the identifier identifying the component of the elevator system associated with the node. The icon may include a pictogram identifying types of components of the elevator system. The icons may include information, such as text, related to attributes of the nodes, particularly the identifier attribute of the node, or a representation thereof. For example, the icon representing a component may include the component's identifier, e.g. as a text, or an identifier related to the component's identifier.

In an exemplary elevator system, according to an aspect, the component identifier may be “landing door 1 of 5”, the identifier attribute of the graph node representing the component may be identical to the component identifier or a processed version of the landing door component identifier, such as “landing door 1”, “LD 1” or “Floor 1”. The icon representing the node may include text identical to the identifier attribute, a shortened text derived from the identifier attribute, a graphical icon visually identifiable as a landing door, a mix of a graphical icon and a text, or any combination thereof.

According to an aspect, the visual representation includes icon modifiers representing the health indicator attribute of the nodes. The icon modifiers may be associated with the icons. The icon modifiers may be associated with the icon representing the node, i.e. an icon and an icon modifier may, together, represent a node and the health indicator attribute of the node. Icon modifiers may be visual modifiers of the icon. For example, according to an aspect, the icon modifier may be a color of the icon, the color being indicative of the health indicator attribute. An icon modifier may modify the color of the icon according to the health indicator attribute, such as a green icon modifier representing the health indicator attribute “OK”, a yellow icon modifier representing the health indicator attribute “Warning” and a red icon modifier representing the health indicator attribute “Fail”. Further exemplary icon modifiers include flashing icons, shaking icons, pulsating icons, providing visually identifiable outlines to the icon, modifying the geometric shape of the icon, modifying the pictographic representation of the icon, adding pictograms or sub-icons, such as an exclamation point to the icon, or the like.

According to an aspect, the visual representation of the graph includes lines representing the links. The lines may be lines visually connecting the icons according to the links of the graph. The lines may be straight lines, curved lines or even complex shaped lines. Dotted lines, dashed lines or the like are considered lines.

According to an aspect, the visual representation of the graph may include line modifiers representing the communication indicator attribute of the links. The line modifier may be a line thickness and/or a line markup, the line thickness and/or line markup being indicative of the communication indicator attribute. The line modifiers may be associated with the lines. The line modifiers may be associated with the line representing the communicative connection between two nodes, i.e. a line and a line modifier may, individually or in combination, represent a connection between communicatively connected components of the elevator system and the communication indicator attribute of the communication between the communicatively connected components. Line modifiers may be visual modifiers, markups or features of the line. For example, line modifiers may modify the thickness of the line according to the communication indicator attribute, such as a thick line modifier representing the communication indicator attribute “Strong signal”, i.e. good connection having a good communication quality, and a thin line modifier representing the communication indicator attribute “Weak signal”, i.e. a bad connection having a low communication quality. Line modifiers may further include changing a solid line into a dashed line or a dotted line, for example, a dashed line, such as a thin dashed line, may represent the communication indicator attribute “No signal”, i.e. no connection having no connection quality. Further exemplary line modifiers include flashing the line, modifying the geometric shape of the line, adding pictograms or icons, such as an exclamation point to the line, or the like. Line modifiers may include changing the color of the line, for example according to aspects described in relation to the icon modifiers.

According to an aspect, the visual representation of the graph may include icon modifiers representing the communication indicator attribute of at least one link associated to the node represented by the icons. The icon modifier may be the same icon modifier described with reference to the icon modifier representing the health indicator attribute of the node, for example, the icon modifier may represent both the health indicator attribute of the node and the communication indicator attribute of at least one link associated with the node. For example, a component may have an icon modifier indicating a failed component, even if the component may be functional, due to the communication between the component and a communicatively connected component being interrupted. The icon modifier may also be a separate icon modifier, e.g. a first type of icon modifier may represent the health indicator attribute, and a second type of icon modifier may represent the communication indicator attribute.

According to an aspect, the graph may include a root node indicative of the overall health of the elevator system, the overall health of the elevator system being defined by the lowest health or health indicator of a component of the elevator system and/or of a node of the graph. The lowest health indicator of a node of a graph may be the lowest health indicator attribute, or derived or derivable therefrom. The root node may be arbitrarily identified, by an identifier attribute associated with the node, or even have no identifier. Possible identifiers include, but are not limited to, “Start”, “Elevator”, “System”, or the like.

According to an aspect, the processing module may be configured for calculating, from the status information, a motion indicator, the motion indicator being indicative of whether the elevator system is in a state (potentially) allowing a movement of moveable parts in the elevator system. The motion indicator may be derived from the status information received from the elevator system, and may particularly be derivable from the health indicators, or even a separate indicator included in the status information, such as an indicator indicating a maintenance state or an operational state. The motion indicator may, additionally or alternatively, be provided by the elevator system and be included in the status information. The motion indicator may include a binary value, i.e. the motion indicator may indicate if the elevator system may allow movement of any component of the elevator system. Beneficially, the motion indicator may indicate if the elevator is in a safe state that allows safe maintenance of the elevator system, or if the elevator system is in a state that does not allow safe maintenance. The motion indicator may be included in an unconnected node in the graph, the graph still being considered a tree-type graph in the context of this disclosure, or the motion indicator may be included as a motion indicator attribute in a dedicated node in the graph, or the motion indicator attribute may be included in a safety-associated node in the graph, or the motion indicator attribute may be included in the root node of the graph.

According to an aspect, the visual representation may include a motion icon representative of the motion indicator, the motion icon having a motion icon modifier being representative of whether the elevator system is in a state allowing a movement of moveable parts in the elevator system. The motion icon may, in the visual representation, be connected to an icon with a line, or may be unconnected. The motion icon and/or the motion icon modifier may be displayed as described with respect to aspects relating to icons and icon modifiers. For example, the motion icon may be a green geometric shape, such as a hexagon or an octagon, including the text “No moving parts” if the motion indicator attribute indicates a safe state for maintenance, and be a red geometric shape, such as a hexagon or an octagon, including the text “Caution” or “Moving parts” if the motion indicator attribute indicates an unsafe state for maintenance.

According to an aspect, the device may include an input device, the input device being configured for recording a user input to allow a user selection of a subset of nodes. Displaying the visual representation of the graph may include displaying only icons and lines of the subset of nodes according to the user selection. The input device may, for example, include a touch-screen, such as a touch-screen included in the visual output module. The input device may further include input devices common in the art, such as keys or a keyboard, a mouse or pointer device, a scroll wheel or the like. The user may select a subset of nodes by selecting a parent node, such that only sub-nodes of the parent node are displayed. The user may select a subset of nodes by negatively selecting, i.e. excluding and/or not displaying, certain nodes or sub-nodes, e.g. a set of nodes not relevant for detecting faults in an elevator system, such as a set of nodes not showing a fault. Displaying only a selection of a subset of nodes may beneficially allow an easier detection of faults, since the user has the ability to focus on faults specific for the selected subset of nodes. This may beneficially improve the efficiency of detecting faults.

According to an aspect, the device may include an output device, such as a speaker or a vibrator. The processing module may be configured for detecting alarm signals representing alarms of the elevator system within the status information. The processing module may be configured for controlling the output device if an alarm is detected. For example, if an elevator alarm is detected, the device may be configured for vibrating.

Further advantages, features, aspects and details that can be combined with embodiments described herein are evident from the description and the drawings.

### DESCRIPTION OF THE DRAWINGS

The details will be described in the following with reference to the figures, wherein:

FIG. 1 schematically shows an elevator system and a device for detecting faults in an elevator system according to an embodiment;

FIG. 2 schematically shows a health status graph of an elevator system according to an embodiment;

FIG. 3 schematically shows a visual representation of a graph of an elevator system according to an embodiment; and

FIG. 4 shows a method of detecting faults in an elevator system according to an embodiment.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment applies to a corresponding part or aspect in another embodiment as well.

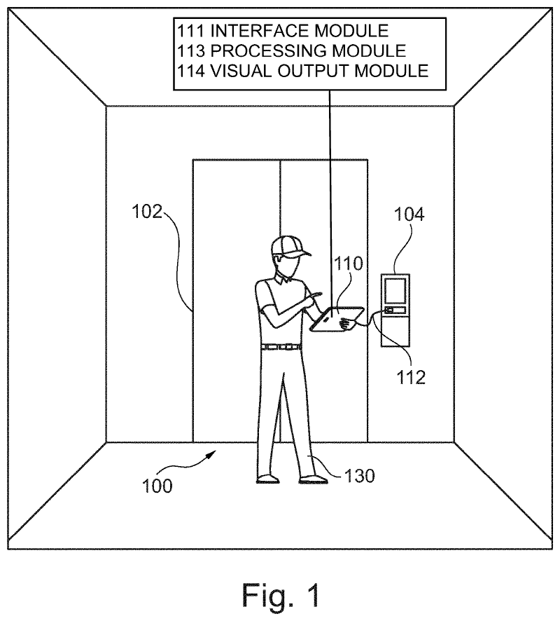

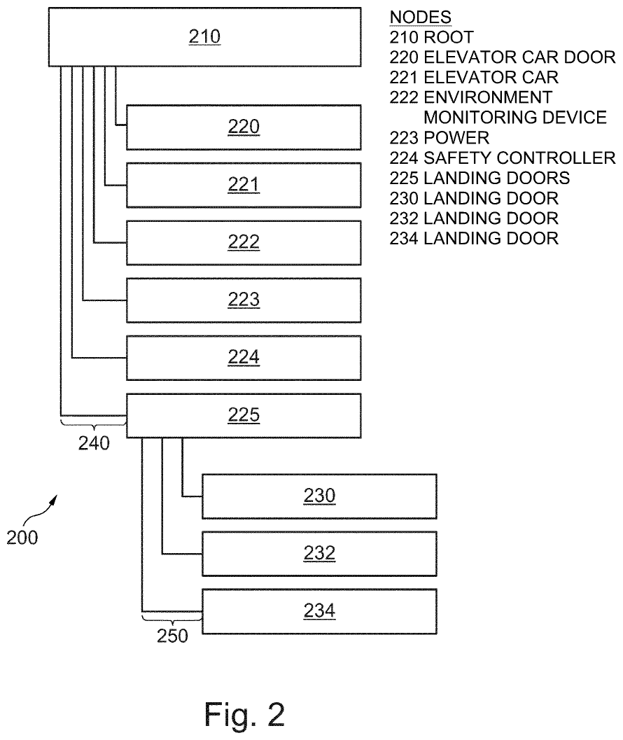

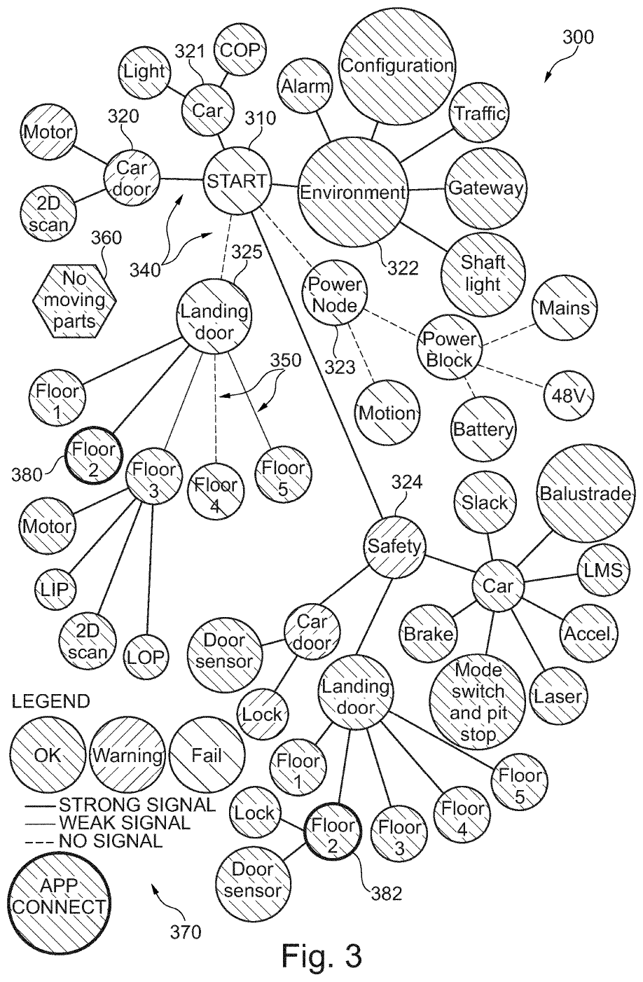

Referring now to FIG. 1, an elevator system 100 in a maintenance scenario is shown. The elevator system includes a landing door 102 and a landing operating panel (LOP) 104. The elevator system 100 may include several additional components (not shown), such as a car movably provided in a shaft for allowing passengers to travel in the car between different levels. Such additional components are described in further detail with reference to FIGS. 2 and 3. A maintenance technician 130 is shown using a device 110 for detecting faults in the elevator system 100. The device 110 is a handheld tablet according to aspects and/or embodiment described herein. The device 110 is connected, by a wired connection 112, to an interface of the elevator system, the interface being provided as a port in the LOP 104. The wired connection 112 allows an interface module 111 included in the device 110 to receive status information from the elevator system 100.

According to embodiments, the wired connection 112 may be instead be a wireless connection. The connection between the device 110 and the elevator system 100 may also be established with other components of the elevator system, or even remotely, e.g. via the internet.

Referring now to FIG. 2, a health status graph 200 of an elevator system, such as the elevator system 100, according to an embodiment is shown. The graph 200 is simplified for clarity, and may be more complex. The graph 200 has a root node 210 and six nodes directly connected, by links 240, to the root node 210.

According to embodiments, the graph 200 may be calculated, i.e. generated and/or created, by a device such as the device 110, particularly a processing module 113 (FIG. 1) of the device. The graph 200 may be calculated automatically upon receiving the status information from the elevator system. Particularly, the graph 200 may be generated individually for each elevator system and thus be variable according to the components present in the elevator system. Furthermore, the graph 200 may be generated repeatedly and/or continuously, e.g. for monitoring changes in the health of the elevator system essentially in real-time.

Node 220 represents the elevator car door, or car door. Node 221 represents the elevator car, or car. Node 222 represents the environment monitoring device. Node 223 represents the power node. Node 224 represents the safety controller. Node 225 represents the landing doors, i.e. a group of landing doors.

According to embodiments, each of the nodes 220-225 may represent or be associated with several components or sub-components of the elevator system (not shown), i.e. the nodes 220-225 may be virtual nodes and/or grouping nodes. Likewise, the root node 210 may be a virtual node representing the overall health status of the elevator system.

For example, as shown in FIG. 2, the elevator system may include three landing doors, and health indicators of the three landing doors may be included in the status information. Accordingly, the graph includes three nodes 230, 232, 234 representative of the individual landing doors and linked to the node 225 representing the group of landing doors via the links 250.

Health indicator attributes for each of the nodes 210, 220-225, 230, 232, 234 are included in the graph, e.g. in a memory of the device 110 associated with the node. Communication indicator attributes for each link 240, 250 between the nodes 210, 220-225, 230, 232, 234 are included in the graph, e.g. in a memory of the device associated with a pair of linked nodes. In a first example, the node 230 representing a first landing door may have stored a health indicator attribute indicating a good health, and the link 250 between the node 230 and the node 225 may have stored a communication indicator attribute indicating a good connection. In a second example, the node 232 representing a second landing door may have stored a health indicator attribute indicating a fault of a sub-component of the landing door, and the link 250 between the node 232 and the node 225 may have stored a communication indicator attribute indicating a good connection. In a third example, the node 234 representing a third landing door may have stored a health indicator attribute indicating a fault due to no health indicator being received for the third landing door, and the link 250 between the node 234 and the node 225 may have stored a communication indicator attribute indicating no connection.

According to embodiments, the graph 200 may include nodes representing one, some or all of the following components or sub-components. The hierarchical structure described in the following typically is a result of the communicative connection between the components and/or sub-components, and may thus be variable and/or specific for each elevator system. Specifically, the hierarchical structure of the graph 200 may be a result of the communication layout of the elevator system, i.e. a component may have a communicatively connected sub-component, and the sub-component may itself have communicatively connected sub-components, i.e. sub-sub-components. The designators of the components may be the identifier of the component, and the corresponding node may be designated, e.g. according to an identifier attribute.

According to embodiments, some components may be optional and not present in some elevator systems, while additional components not described in the following may be present in some elevator systems and included in the graph without deriving from the scope of this disclosure. An elevator system as described herein, and/or the graph calculated from the status information of the elevator system, may include any of the components described in the following:

The “car door” component may be a car door controller, as represented by the car door node 220. The “car door” may have the sub-component “motor”, i.e. a car door motor for opening and closing the car door.

The “car door” component may have the sub-component “2D scan”, such as an infrared safety curtain.

The “car” component may be a car controller, as represented by the car node 221. The “car” may have the sub-component “COP”, i.e. a car operating panel. The “car” may have the sub-component “light”, i.e. one or more elevator car lights.

The “environment” component may be an environment controller and/or environment monitoring device, as represented by the environment monitoring device node 222. The “environment” may have the sub-component “alarm”, such as a device for sending and/or receiving alarms. The “environment” may have the sub-component “configuration”, such as a device for storing and/or receiving configurations of the elevator system. The “environment” may have the sub-component “traffic”, such as a device for monitoring elevator traffic and/or adjusting the elevator configuration according to traffic. The “environment” may have the sub-component “gateway”, such as a device for communicatively connecting the elevator system, e.g. an elevator controller, to a wide-area network such as the internet. The “environment” may have the sub-component “shaft light”, i.e. one or more lights for lighting the elevator shaft.

The “power node” component may be a power node, such as a power node of the elevator drive for controlling the elevator drive, as represented by the power node node 223. The “power node” may have the sub-component “motion”, e.g. a motion controller controlling the motion of the elevator drive. The “power node” may have the sub-component “power block”, such as a device for receiving, converting and/or providing power, e.g. for powering the power node, the elevator drive and/or motor, and/or further components of the elevator system. The “power block” may have the sub-component “mains”, e.g. a connection to a power grid. The “power block” may have the sub-component “48V”, e.g. a connection to a 48 Volt power supply. The 48 Volt power supply may be an external power supply, or included in the power block. The “power block” may have a sub-component “battery”, e.g. a connection to a battery, such as a backup-battery, an uninterruptible power supply battery or an emergency battery. The battery may be charged and/or monitored by an external device, or by the power block. The communicative connection of the component “power block” and the sub-components “mains”, “48V” and/or “battery” may be an electrical connection, i.e. the communication may comprise monitoring the power provided to and/or from the sub-component.

The “safety” component, as represented by the safety controller node 224, may be a safety controller. A safety controller may be one safety controller, or a plurality of (interconnected) safety controllers. The “safety” component may be a virtual component, i.e. the safety controller node 224 may represent a set of (separate) safety controllers.

The “safety” component may have the sub-component “car door”. The “car door” component may be a safety controller of the car door, or be included in the car door controller. The “car door” component may have the sub component “door sensor”. The “door sensor” may be a sensor for sensing the state of the door, particularly for sensing safety-relevant information, such as whether the door is open or closed, obstructed or the like. The “car door” component may have the sub-component “lock”. The “lock” may be a lock or a sensor associated with the lock, particularly for sensing if the car door is locked.

The “safety” component may have the sub-component “car”. The “car” component may be a safety controller of the car, or be included in the car controller. The “car” component may have the sub-component “slack”, e.g. a slack sensor or slack switch for monitoring the slack of a cable, such as a hoisting cable. The “car” component may have the sub-component “balustrade”, e.g. a sensor for monitoring a balustrade provided on the elevator car roof, particularly for monitoring if maintenance is being performed on the elevator car roof. The “car” component may have the sub-component “LMS”, i.e. a load measurement system. The “car” component may have the sub-component “accelerometer”, i.e. an accelerometer sensor for sensing the acceleration of the elevator car. The “car” component may have the sub-component “laser”, i.e. a laser position sensor for sensing the position of the elevator car within the shaft, e.g. an absolute level of the car. The “car” component may have the sub-component “mode switch and pit stop”, i.e. one or more switches provided on the car roof and/or the shaft pit for stopping the operation of the elevator system during maintenance. The “car” component may have the sub-component “brake”, i.e. a brake and/or safety brake of the elevator car and/or a sensor associated with the brake.

The “safety” component may have the sub-component “landing door”. The “landing door” component may be a safety controller of the landing door or landing doors, or a safety controller aggregating safety-relevant data from the landing doors. The landing door safety controller corresponding to a sub-node “landing door” of the node safety controller node 224 may be one safety controller, or a plurality of (interconnected) safety controllers. The “landing door” component may be a virtual component, i.e. the “landing door” sub-node may represent a set of (separate) safety controllers.

The “landing door” component may have a plurality of sub-components corresponding to the landing doors of the elevator system, such as a sub-component for each landing door. The sub-components may be designated “floor X” or “landing door X”, with X being the floor number, such as “floor 1”, “floor 2” or the like. The “floor X” component may be a safety controller of the landing door, or be included in the landing door controller. The “floor X” component, particularly some or all of the “floor X components”, may have the sub component “door sensor”. The “door sensor” may be a sensor for sensing the state of the door, particularly for sensing safety-relevant information, such as whether the door is open or closed, obstructed or the like. The “floor X” component(s) may have the sub-component “lock”. The “lock” may be a lock or a sensor associated with the lock, particularly for sensing if the landing door is locked.

The “landing door” component, as represented by the landing door node 225, may have a plurality of sub-components corresponding to the landing doors of the elevator system, such as a sub-component for each landing door. The sub-components may be designated “floor X” or “landing door X”, with X being the floor number, such as “floor 1”, “floor 2” or the like. The “floor X” component may be a controller of the landing door. The controller of the landing door may include the safety controller of the landing door, or be a separate controller.

The “floor X” component, particularly some or all of the “floor X components”, may have the sub-component “motor”, i.e. a motor for opening or closing the landing door. The “floor X” component(s) may have the sub-component “LIP”, i.e. a landing indicator panel. The “floor X” component(s) may have the sub-component “2D scan”, such as an infrared safety curtain. The “floor X” component(s) may have the sub-component “LOP”, i.e. a landing operating panel.

Referring now to FIG. 3, a visual representation 300 of a graph of an elevator system according to an embodiment is shown schematically. Aspects of the embodiment shown in FIG. 3 may be applicable to the graph shown in FIG. 2. The graph described with respect to FIG. 2 may include some or all of the aspects of the visual representation of the graph shown in FIG. 3. The visual representation 300 may include some or all aspects of the graph 200 shown in FIG. 2.

According to embodiments, the visual representation shown in FIG. 3 may be a visual representation as displayed by the device 110, i.e. the visual output module 114 (FIG. 1) of the device. The shown visual representation is given as an example obtainable when detecting faults in an elevator system, such as the elevator system 100, by a device, such as the device 110. Components of the elevator system displayed in the visual representation 300 show exemplary states given here for explanation, i.e. the information in the visual representation 300 is variable according to the state of the elevator system being diagnosed.

The visual representation 300 has a root icon “START” 310 corresponding to the root node 210. The icons 320-325 correspond to the nodes 220-225. In the visual representation 300, the icons 310, 323 and 325 may be colored red, indicating a failure, as clarified in the legend 370. Likewise, the lines 340 connecting the icon 310 to the icons 325 and 323 are dashed, indicating “no signal” as clarified in the legend 370.

Based on the visual representation 300, a user, such as the technician 130, may proceed with identifying the fault. The icon “landing door” 325 is red and the dashed line 340 indicate a fault and no connection, however, there is a connection between the icons representing “Floor 1”, “Floor 2” 380, “Floor 3” and “Floor 5”, thus, a communication between the landing door and the landing door controllers is possible and the landing door controller is functional, i.e. the health indicator attribute and the communication indicator attribute were inherited from the node represented by the icon “Floor 4”. Thus, the fault, in this example, results from the component represented by the icon “Floor 4” and may be caused either by a failure of the component “Floor 4” or a loss of communication between the component “Floor 4” and “Landing door” represented by icon 325. Further diagnosis may therefore be performed for this component and/or the connection of the component.

The user may further identify a second fault resulting from the “Power node” represented by the icon 323. As shown in the visual representation 300, all sub-icons representing the sub-nodes or sub-components of the “Power node” show a failure and no communication. Thus, the user may conclude that a fault may be present in the “Power node” or a connection connecting the “Power node” to the elevator system.

In the visual representation 300, the icons 320, 324 and the sub-icon of icon 320 “Motor”, as well as the sub-icons of icon 324 “Lock” and “Car door” may be colored yellow, indicating a warning, as clarified in the legend 370. The user may conclude, from the visual representation 300, that the “Warning”-state is inherited from the icons “Motor” and “Lock”. Consequently, the user may perform e.g. preventative maintenance on these components to prevent further deterioration or even failure.

In the visual representation 300, the lines 350 connecting the icons “Floor 3” and “Floor 5” with the icon 325 are drawn as thin lines, indicating a “weak signal”. Thus, the user may conclude, based on the visual representation, that the communication between the represented components is unstable, and may act accordingly.

All other icons in the visual representation 300 may be green, as described in the legend 370, indicating that the represented components are “OK”. All other lines in the visual representation 300 may be drawn as thick lines, indicating a “strong signal”. Thus, the user may conclude that no maintenance is required for these components.

As shown in FIG. 3, according to embodiments, the visual representation 300 may include a motion icon 360. In the shown example, the elevator system is in a state safe for maintenance having no moving parts, thus, the icon 360 is colored green and shows the text “No moving parts”. In a case where the elevator system is in an unsafe state, i.e. has moving parts, the icon 360 may be colored red and show the text “Caution—moving parts”, or a similar text.

As shown in FIG. 3, according to embodiments, the visual representation 300 may include icons 380, 382 with additional icon modifiers. In FIG. 3, the icons 380, 382 have a thick outline. The thick outline indicates that the device, such as the device 110, is connected, to a port provided by the component represented by the icon. In the shown example, the device 110 is connected to “Floor 2”, e.g. a landing door controller of the second floor.

As shown in FIG. 3, according to embodiments, the visual representation 300 may only show a selection of icons. Particularly, the icons representing sub-components of the door controllers of “Floor 1”, “Floor 2” and “Floor 5” are not shown, and the icons representing sub-components of the door safety controllers of “Floor 1”, “Floor 3”, “Floor 4” and “Floor 5” are not shown. This may be selectable by the user, e.g. by clicking or touching an icon, to selectively include or exclude the sub-icons of the icon. The selection of nodes may be a filter. The filter may choose a subset of icons representative of elevator components based on a property, such as an attribute, of the elevator component. The property may include a communication indicator attribute, e.g. representing a signal strength, a health indicator attribute, e.g. representing a status, or the like. Likewise, according to embodiments, the visual representation 300 may allow dragging and dropping icons into certain positions, or resizing icons or icon groups according to the preference of the user. Such controllable icon modifications may improve visibility, and/or facilitate detecting faults in the elevator system. According to embodiments, the device 110 may be configured for allowing a selection according an attribute of the node represented by the icon. For example, only icons representing a node having a health indicator attribute and/or a connection indicator attribute above or below a certain threshold may be displayed. Likewise, only icons representing a type of component may be selectable, such as icons related to doors, icons related to motors, icons related to sensors or the like.

According to embodiments, a visual representation, such as the visual representation 300 shown in FIG. 3, may selectively display additional information. The additional information may, for example, be displayed upon selecting a node in the visual representation of the graph, e.g. by selecting an icon associated with the node, and/or selecting a line associated with a link. The additional information may, for example, be displayed in a separate screen section, and/or be displayed in an overlay, such as an overlay window, text bubble or the like, that reversibly opens upon selecting the node and/or line. The additional information may be at least partially text-based, particularly essentially text-based. The additional information may include detailed diagnostics, such as detailed diagnostics associated with the selected node, e.g. display additional data related to the node and/or the associated elevator component. The detailed diagnostics may include, for example, one or more of an error log, an error cause, a (recommended) action, such as an action to be performed in response to a cause, a detailed status of the node or the like. The detailed diagnostics may be included in the status information received from the elevator system, or derived therefrom. The detailed diagnostics may be obtainable as described with respect for the health status indicators and/or communication indicators, and/or the health indicator attributes and/or communication indicator attributes derived therefrom. The detailed diagnostics may be data obtained or obtainable during calculating the graph. The detailed diagnostics may be included in the graph, e.g. as an attribute of a node or link, such as a detailed health indicator attribute and/or detailed communication indicator attribute.

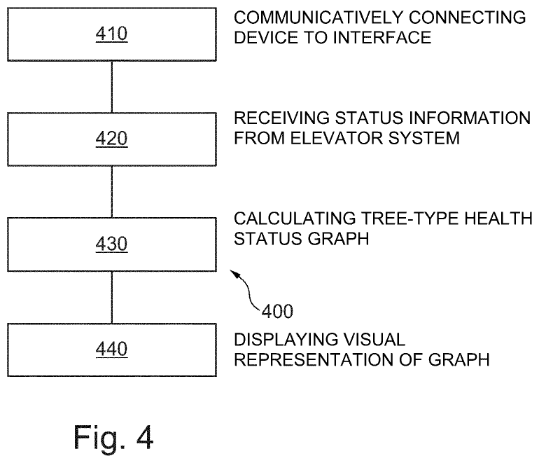

As shown in FIG. 4, according to embodiments, a method 400 of detecting faults in an elevator system is described. The method 400 includes communicatively connecting in a step 410 a device to an interface of the elevator system, and receiving in a step 420 status information from the elevator system, the status information including health indicators indicative of the health of components of the elevator system, and communication indicators indicative of the communication quality between communicatively connected components of the elevator system. The method 400 further includes calculating in a step 430, from the status information, a tree-type health status graph of the elevator system. The graph includes nodes representing the components of the elevator system, each node including a health indicator attribute based on the health indicator of the components associated with the node. The graph further includes links between nodes, the links representing the connection between communicatively connected components of the elevator system, each link including a communication indicator attribute based on the communication indicator of the communicatively connected components associated with the link. The method 400 further includes displaying in a step 440 a visual representation of the graph of the elevator system. The visual representation of the graph includes icons representing the nodes, icon modifiers representing the health indicator attribute of the nodes, lines representing the links.

According to embodiments, the method 400 may include displaying in the step 440 a visual representation of the graph of the elevator system, the visual representation of the graph including line modifiers representing the communication indicator attribute of the links.

According to embodiments, the method 400 may include performing operations according to aspects and/or embodiments described with respect to a device described herein, such as the device 110, particularly aspects and/or embodiments related to the generation of the graph and/or the displaying of the visual representation. The visual representation may be a visual representation 300 as described with reference to FIG. 3.

According to embodiments, an elevator system is described. The elevator system may include a device, such as the device 110, for detecting faults in an elevator system, according to aspects and/or embodiments described herein. The elevator system may be an elevator system according to aspects and/or embodiments described herein, such as the elevator system 100.

According to embodiments, the use of a device, such as the device 110, for detecting faults in an elevator system, according to aspects and/or embodiments described herein, is described. The elevator system may be an elevator system according to aspects and/or embodiments described herein, such as the elevator system 100. Use of the device may include a use according to a method according to aspects and/or embodiments described herein, such as the method 400.

The device and method described herein may beneficially allow generating a comprehensive, accessible representation of the elevator system, including information of relevant health and communication indicators suitable for detecting, monitoring and diagnosing faults or warnings. This may reduce the time and effort required for fault detection, and may further allow maintenance technicians to perform diagnosis even for elevator systems without an in-depth knowledge of the components and topology of the elevator system. As a result, even preventative maintenance may be possible with low effort, thus reducing faults, downtime and potential costs for the owner of the elevator system.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A device for detecting faults in an elevator system, the device comprising:
an interface module adapted to connect the device to an interface of the elevator system;
a visual output module;
a processing module, wherein when the interface module is connected to the interface of the elevator system, the processing module receives through the interface module status information from the elevator system;
wherein the status information includes health indicators indicative of a health of components of the elevator system and communication indicators indicative of a communication quality between communicatively connected ones of the components of the elevator system;
wherein the processing module calculates, from the status information, a tree-type health status graph of the elevator system;
wherein the graph includes nodes representing the components of the elevator system, each of the nodes having a health indicator attribute based on the health indicator of the components associated with the node, and links between nodes, the links representing a connection between communicatively connected ones of the components of the elevator system, each of the links having a communication indicator attribute based on the communication indicator of the communicatively connected components associated with the link; and
wherein the processing module displays, by the visual output module, a visual representation of the graph, the visual representation including icons representing the nodes, icon modifiers representing the health indicator attributes of the nodes and lines representing the links.

17. The device according to claim 16 wherein the visual representation of the graph includes a line modifier representing the communication indicator attribute of one of the links and/or an icon modifier representing the communication indicator attribute of one of the links associated with one of the nodes.

18. The device according to claim 16 wherein the device is a tool adapted for use by a service technician.

19. The device according to claim 16 wherein one of the icon modifiers is a color of the icon, the color being indicative of the health indicator attribute.

20. The device according to claim 16 wherein the visual representation of the graph includes a line modifier representing the communication indicator attribute of one of the links, the line modifier being a line thickness and/or a line markup, the line thickness and/or line markup being indicative of the communication indicator attribute.

21. The device according to claim 16 wherein the visual representation of the graph includes, for each of the nodes, an identifier, the identifier identifying the component of the elevator system associated with the node.

22. The device according to claim 21 wherein the status information includes the identifiers of the components of the elevator system, and wherein each node has an identifier attribute based on the identifier of the component of the elevator system represented by the node.

23. The device according to claim 16 wherein the graph includes a root node indicative of an overall health of the elevator system, the overall health of the elevator system being based upon a lowest health of the nodes of the graph.

24. The device according to claim 23 wherein the graph includes a group of the nodes directly connected to the root node, one of the nodes of the group of nodes representing a group of landing doors, a car door, a car, an environment monitoring device, a power node or a safety controller.

25. The device according to claim 16 wherein the processing module calculates, from the status information, a motion indicator being indicative of whether the elevator system is in a state allowing a movement of moveable parts in the elevator system, and wherein the visual representation includes a motion icon representative of the motion indicator, the motion icon having a motion icon modifier being representative of whether the elevator system is in a state allowing a movement of the moveable parts in the elevator system.

26. The device according to claim 16 wherein the device records a user input representing a user selection of a subset of the nodes, and wherein the visual representation of the graph includes only the icons and the lines of the subset of the nodes according to the user selection.

27. The device according to claim 16 wherein the interface module is a networking module connecting the device to a network of the elevator system, the network communicatively connecting the components of the elevator system.

28. An elevator system comprising an interface and the device according to claim 16, wherein the interface module of the device is connected to the interface.

29. A method of detecting faults in an elevator system, the method comprising the steps of:
communicatively connecting the device according to claim 16 to an interface of the elevator system,
receiving status information from the elevator system by the device, the status information including health indicators indicative of a health of components of the elevator system and communication indicators indicative of a communication quality between communicatively connected ones of the components of the elevator system;
calculating by the device, from the status information, a tree-type health status graph of the elevator system, the graph including nodes representing the components of the elevator system, each of the nodes having a health indicator attribute based on the health indicator of the components associated with the node, and links between nodes, the links representing a connection between the communicatively connected components of the elevator system, each of the links having a communication indicator attribute based on the communication indicator of the communicatively connected components associated with the link; and
displaying a visual representation of the graph of the elevator system, the visual representation including icons representing the nodes, icon modifiers representing the health indicator attribute of the nodes, and lines representing the links.

30. The method according to claim 29 wherein at least one of the health indicator attributes represents a fault in the elevator system.

31. The method according to claim 29 wherein the visual representation includes line modifiers representing the communication indicator attribute of the links.

32. The method according to claim 31 wherein at least one of the communication indicator attributes represents a fault in the elevator system.
